(19) United States
(12) Patent Application Publication
(10) Pub. No.: US 2003/0203809 A1
(43) Pub. Date: Oct. 30, 2003

(54) Method for preparing a catalyst composition and its use in a polymerization process

(76) Inventors: Sun-Chueh Kao, Belle Mead, NJ (US); Jaimes Sher, Houston, TX (US); Parul A. Khokhani, Manalapan, NJ (US); Natarajan Muruganandam, Belle Mead, NJ (US); Frederick J. Karol, Lakewood, NJ (US)

Correspondence Address: UNIVATION TECHNOLOGIES LLC, 5555 SAN FELIPE, SUITE 1950, HOUSTON, TX, 77056, US

(21) Appl. No.: 10/430,920

(22) Filed: May 7, 2003

Related U.S. Application Data
(62) Division of application No. 09/715,775, filed on Nov. 17, 2000.

(51) Int. Cl. B01J 31/00

(52) U.S. Cl. 502/150; 502/132; 502/104

(57) ABSTRACT

The present invention relates to a catalyst composition of an activator, a support, a catalyst compound and an ionizing activator and its use in a process for polymerizing olefin(s). The invention is also directed to a method for making the catalyst composition above.

### RELATED APPLICATION DATA

The present application is a divisional of U.S. patent application Ser. No. 09/715,775, filed Nov. 17, 2000, now issued as U.S. Pat. No. ______.

### FIELD OF THE INVENTION

The present invention relates generally to the field of bulky ligand metallocene catalysts and their use for olefin(s) polymerization. In particular, the invention is directed to a catalyst composition, with enhanced activity, which includes a bulky ligand metallocene catalyst compound, and a method for preparing such a composition. More specifically, the present invention is directed to a supported catalyst composition comprising a bulky ligand metallocene catalyst compound, an activator compound, and an ionizing activator compound, to a method of preparing such a catalyst composition, and for its use in the polymerization of olefin(s).

### DESCRIPTION OF RELATED ART

Numerous catalysts and catalyst systems have been developed which provide polyolefins with certain advantageous properties. One class of these catalysts are now commonly referred to as metallocenes. Metallocenes are broadly defined as organometallic coordination complexes containing one or more moieties in association with a metal atom from Groups 3 to 17 or the Lanthanide series of the Periodic Table of Elements. These catalysts are highly useful in the preparation of polyolefins, allowing one to closely tailor the final properties of the polymer as desired.

Although metallocene catalysts are used extensively to obtain polyolefins with molecular weight, polydispersity, melt index, and other properties well suited for a desired application, the use of these catalysts is expensive. In addition, to utilize these systems in industrial slurry or gas phases processes, it is useful that they be immobilized on a carrier or support such as, for example silica or alumina. The use of supported catalysts in gas and slurry phase polymerization increases process efficiencies by assuring that the forming polymeric particles achieve a shape and density that improves reactor operability and ease of handling. Bulky ligand metallocene catalysts, however, typically exhibit lower activity when supported than in the corresponding non-supported catalyst systems.

Organoborate and boron compounds are known as activators for olefin polymerization systems. The use of these compounds as activators, to form active olefin polymerization catalysts is documented in the literature. Marks (Marks et al. 1991) reported such a transformation for olefin polymerization using Group 4 metallocene catalysts containing alkyl leaving groups activated with tris(pentafluorophenyl)borane. Similarly, Chien et al. (1991) activated a dimethyl zirconium catalyst with tetra(pentafluorophenyl)borate. However, when Chien used methylalumoxane (MAO) as well as the borate for the activation of the dimethyl zirconium catalyst for the polymerization of propylene, only a small amount of polymer was produced.

In spite of the advances in this technology, there exists a need to provide for supported metallocene catalyst compositions having enhanced activity, for methods of preparing such catalyst compositions, and for their use in the polymerization of olefin(s).

### SUMMARY OF THE INVENTION

The present invention provides for a catalyst composition which includes a bulky ligand metallocene catalyst compound, an activator compound, and an ionizing activator compound. The present invention also provides methods of making the catalyst compositions and a process for polymerizing olefin(s) utilizing them.

In one aspect, the process for preparing the catalyst composition of the invention includes the steps of: (a) supporting an alumoxane on a support material to form a supported alumoxane; (b) contacting a bulky ligand metallocene catalyst with the supported alumoxane; and (c) adding an ionizing activator to the catalyst system.

In another aspect, the process for preparing the catalyst composition of the includes the steps of (a) contacting a bulky ligand metallocene-type catalyst with a supported alumoxane activator and then (b) adding a Group 13 element containing ionizing activator.

In another aspect, the invention is directed towards the inclusion of a cycloalkadiene, such as indene, to the catalyst composition of the invention to further enhance its activity.

### DETAILED DESCRIPTION OF THE INVENTION

The present invention provides a metallocene catalyst composition having enhanced activity, a method for preparing this catalyst composition and a method for polymerizing olefin(s) utilizing same. More specifically, the present invention provides for a supported catalyst system which includes a bulky ligand metallocene catalyst compound, an activator compound, and an ionizing activator, and optionally, a cycloalkadiene, which acts as a further activity enhancer.

I. Bulky Ligand Metallocene Catalyst Compounds

The catalyst composition of the invention includes a bulky ligand metallocene catalyst compound. Generally, these catalyst compounds include half and full sandwich compounds having one or more bulky ligands bonded to at least one metal atom. Typical bulky ligand metallocene compounds are described as containing one or more bulky ligand(s) and one or more leaving group(s) bonded to at least one metal atom.

The bulky ligands are generally represented by one or more open, acyclic, or fused ring(s) or ring system(s) or a combination thereof. The ring(s) or ring system(s) of these bulky ligands are typically composed of atoms selected from Groups 13 to 16 atoms of the Periodic Table of Elements. Preferably the atoms are selected from the group consisting of carbon, nitrogen, oxygen, silicon, sulfur, phosphorous, germanium, boron and aluminum or a combination thereof. Most preferably the ring(s) or ring system(s) are composed of carbon atoms such as but not limited to those cyclopentadienyl ligands or cyclopentadienyl-type ligand structures or other similar functioning ligand structure such as a pentadiene, a cyclooctatetraendiyl or an imide ligand. The metal atom is preferably selected from Groups 3 through 15 and the lanthanide or actinide series of the Periodic Table of Elements. Preferably the metal is a transition metal from Groups 4 through 12, more preferably Groups 4, 5 and 6, and most preferably the transition metal is from Group 4.

In one embodiment, the catalyst composition of the invention includes a bulky ligand metallocene catalyst compound represented by the formula:

L^{A}L^{B}MQₙ (I)

where M is a metal atom from the Periodic Table of the Elements and may be a Group 3 to 12 metal or from the lanthanide or actinide series of the Periodic Table of Elements, preferably M is a Group 4, 5 or 6 transition metal, more preferably M is zirconium, haftium or titanium. The bulky ligands, L^{A} and L^{B}, are open, acyclic or fused ring(s) or ring system(s) and are any ancillary ligand system, including unsubstituted or substituted, cyclopentadienyl ligands or cyclopentadienyl-type ligands, heteroatom substituted and/or heteroatom containing cyclopentadienyl-type ligands. Non-limiting examples of bulky ligands include cyclopentadienyl ligands, cyclopentaphenanthreneyl ligands, indenyl ligands, benzindenyl ligands, fluorenyl ligands, octahydrofluorenyl ligands, cyclooctatetraendiyl ligands, cyclopentacyclododecene ligands, azenyl ligands, azulene ligands, pentalene ligands, phosphoyl ligands, phosphinimine (WO 99/40125), pyrrolyl ligands, pyrozolyl ligands, carbazolyl ligands, borabenzene ligands and the like, including hydrogenated versions thereof, for example tetrahydroindenyl ligands. In one embodiment, L^{A} and L^{B} may be any other ligand structure capable of η-bonding to M, preferably η³-bonding to M and most preferably η⁵-bonding. In yet another embodiment, the atomic molecular weight (MW) of L^{A} or L^{B} exceeds 60 a.m.u., preferably greater than 65 a.m.u.. In another embodiment, L^{A} and L^{B} may comprise one or more heteroatoms, for example, nitrogen, silicon, boron, germanium, sulfur and phosphorous, in combination with carbon atoms to form an open, acyclic, or preferably a fused, ring or ring system, for example, a hetero-cyclopentadienyl ancillary ligand. Other L^{A} and L^{B} bulky ligands include but are not limited to bulky amides, phosphides, alkoxides, aryloxides, imides, carbolides, borollides, porphyrins, phthalocyanines, corrins and other polyazomacrocycles. Independently, each L^{A} and L^{B} may be the same or different type of bulky ligand that is bonded to M. In one embodiment of formula (I) only one of either L^{A} or L^{B} is present. Independently, each L^{A} and L^{B} may be unsubstituted or substituted with a combination of substituent groups R. Non-limiting examples of substituent groups R include one or more from the group selected from hydrogen, or linear, branched alkyl radicals, or alkenyl radicals, alkynyl radicals, cycloalkyl radicals or aryl radicals, acyl radicals, aroyl radicals, alkoxy radicals, aryloxy radicals, alkylthio radicals, dialkylamino radicals, alkoxycarbonyl radicals, aryloxycarbonyl radicals, carbomoyl radicals, alkyl- or dialkyl- carbamoyl radicals, acyloxy radicals, acylamino radicals, aroylamino radicals, straight, branched or cyclic, alkylene radicals, or combination thereof. In a preferred embodiment, substituent groups R have up to 50 non-hydrogen atoms, preferably from 1 to 30 carbon, that can also be substituted with halogens or heteroatoms or the like. Non-limiting examples of alkyl substituents R include methyl, ethyl, propyl, butyl, pentyl, hexyl, cyclopentyl, cyclohexyl, benzyl or phenyl groups and the like, including all their isomers, for example tertiary butyl, isopropyl, and the like. Other hydrocarbyl radicals include fluoromethyl, fluroethyl, difluroethyl, iodopropyl, bromohexyl, chlorobenzyl and hydrocarbyl substituted organometalloid radicals including trimethylsilyl, trimethylgermyl, methyldiethylsilyl and the like; and halocarbyl-substituted organometalloid radicals including tris(trifluoromethyl)-silyl, methyl-bis(difluoromethyl)silyl, bromomethyldimethylgermyl and the like; and disubstitiuted boron radicals including dimethylboron for example; and disubstituted pnictogen radicals including dimethylamine, dimethylphosphine, diphenylamine, methylphenylphosphine, chalcogen radicals including methoxy, ethoxy, propoxy, phenoxy, methylsulfide and ethylsulfide. Non-hydrogen substituents R include the atoms carbon, silicon, boron, aluminum, nitrogen, phosphorous, oxygen, tin, sulfur, germanium and the like, including olefins such as but not limited to olefinically unsaturated substituents including vinyl-terminated ligands, for example but-3-enyl, prop-2-enyl, hex-5-enyl and the like. Also, at least two R groups, preferably two adjacent R groups, are joined to form a ring structure having from 3 to 30 atoms selected from carbon, nitrogen, oxygen, phosphorous, silicon, germanium, aluminum, boron or a combination thereof. Also, a substituent group R group such as 1-butanyl may form a carbon sigma bond to the metal M.

Other ligands may be bonded to the metal M, such as at least one leaving group Q. For the purposes of this patent specification and appended claims the term “leaving group” is any ligand that can be abstracted from a bulky ligand metallocene catalyst compound to form a bulky ligand metallocene catalyst cation capable of polymerizing one or more olefin(s). In one embodiment, Q is a monoanionic labile ligand having a sigma-bond to M. Depending on the oxidation state of the metal, the value for n is 0, 1 or 2 such that formula (I) above represents a neutral bulky ligand metallocene catalyst compound.

Non-limiting examples of Q ligands include weak bases such as amines, phosphines, ethers, carboxylates, dienes, hydrocarbyl radicals having from 1 to 20 carbon atoms, hydrides or halogens and the like or a combination thereof. In another embodiment, two or more Q's form a part of a fused ring or ring system. Other examples of Q ligands include those substituents for R as described above and including cyclobutyl, cyclohexyl, heptyl, tolyl, trifluromethyl, tetramethylene, pentamethylene, methylidene, methyoxy, ethyoxy, propoxy, phenoxy, bis(N-methylanilide), dimethylamide, dimethylphosphide radicals and the like.

In another embodiment, the catalyst composition of the invention includes a bulky ligand metallocene catalyst compounds of formula (II) where L^{A} and L^{B} are bridged to each other by at least one bridging group, A, as represented in the following formula:

L^{A}AL^{B}MQₙ (II)

These bridged compounds represented by formula (II) are known as bridged, bulky ligand metallocene catalyst compounds. L^{A}, L^{B}, M, Q and n are as defined above. Non-limiting examples of bridging group A include bridging groups containing at least one Group 13 to 16 atom, often referred to as a divalent moiety such as but not limited to at least one of a carbon, oxygen, nitrogen, silicon, aluminum, boron, germanium and tin atom or a combination thereof. Preferably bridging group A contains a carbon, silicon or germanium atom, most preferably A contains at least one silicon atom or at least one carbon atom. The bridging group A may also contain substituent groups R as defined above including halogens and iron. Non-limiting examples of bridging group A may be represented by R′₂C, R′₂Si, R′₂Si R′₂Si, R′₂Ge, R′P, where R′ is independently, a radical group which is hydride, hydrocarbyl, substituted hydrocarbyl, halocarbyl, substituted halocarbyl, hydrocarbyl-substituted organometalloid, halocarbyl-substituted organometalloid, disubstituted boron, disubstituted pnictogen, substituted chalcogen, or halogen or two or more R′ may be joined to form a ring or ring system. In one embodiment, the bridged, bulky ligand metallocene catalyst compounds of formula (II) have two or more bridging groups A (EP 664 301 B1).

In another embodiment, the bulky ligand metallocene catalyst compounds are those where the R substituents on the bulky ligands L^{A} and L^{B} of formulas (I) and (II) are substituted with the same or different number of substituents on each of the bulky ligands. In another embodiment, the bulky ligands L^{A} and L^{B} of formulas (I) and (II) are different from each other.

Other bulky ligand metallocene catalyst compounds and catalyst systems useful in the invention may include those described in U.S. Pat. Nos. 5,064,802, 5,145,819, 5,149,819, 5,243,001, 5,239,022, 5,276,208, 5,296,434, 5,321,106, 5,329,031, 5,304,614, 5,677,401, 5,723,398, 5,753,578, 5,854,363, 5,856,547 5,858,903, 5,859,158, 5,900,517 and 5,939,503 and PCT publications WO 93/08221, WO 93/08199, WO 95/07140, WO 98/11144, WO 98/41530, WO 98/41529, WO 98/46650, WO 99/02540 and WO 99/14221 and European publications EP-A-0 578 838, EP-A-0 638 595, EP-B-0 513 380, EP-A1-0 816 372, EP-A2-0 839 834, EP-B1-0 632 819, EP-B1-0 748 821 and EP-B1-0 757 996, all of which are herein fully incorporated by reference.

In another embodiment, bulky ligand metallocene catalysts compounds useful in the invention include bridged heteroatom, mono-bulky ligand metallocene compounds. These types of catalysts and catalyst systems are described in, for example, PCT publication WO 92/00333, WO 94/07928, WO 91/ 04257, WO 94/03506, WO96/00244, WO 97/15602 and WO 99/20637 and U.S. Pat. Nos. 5,057,475, 5,096,867, 5,055,438, 5,198,401, 5,227,440 and 5,264,405 and European publication EP-A-0 420 436, all of which are herein fully incorporated by reference.

In another embodiment, the catalyst composition of the invention includes a bulky ligand metallocene catalyst compound represented by formula (III):

L^{C}AJMQₙ (III)

where M is a Group 3 to 16 metal atom or a metal selected from the Group of actinides and lanthanides of the Periodic Table of Elements, preferably M is a Group 4 to 12 transition metal, and more preferably M is a Group 4, 5 or 6 transition metal, and most preferably M is a Group 4 transition metal in any oxidation state, especially titanium; L^{C} is a substituted or unsubstituted bulky ligand bonded to M; J is bonded to M; A is bonded to L^{C} and J; J is a heteroatom ancillary ligand; and A is a bridging group; Q is a univalent anionic ligand; and n is the integer 0,1 or 2. In formula (III) above, L^{C}, A and J form a fused ring system. In an embodiment, L^{C} of formula (III) is as defined above for L^{A}, A, M and Q of formula (III) are as defined above in formula (I).

In formula (III) J is a heteroatom containing ligand in which J is an element with a coordination number of three from Group 15 or an element with a coordination number of two from Group 16 of the Periodic Table of Elements. Preferably J contains a nitrogen, phosphorus, oxygen or sulfur atom with nitrogen being most preferred.

In another embodiment, the bulky ligand type metallocene catalyst compound utilized is a complex of a metal, preferably a transition metal, a bulky ligand, preferably a substituted or unsubstituted pi-bonded ligand, and one or more heteroallyl moieties, such as those described in U.S. Pat. Nos. 5,527,752 and 5,747,406 and EP-B1-0 735 057, all of which are herein fully incorporated by reference.

In another embodiment, the catalyst composition of the invention includes a bulky ligand metallocene catalyst compound represented formula IV:

L^{D}MQ₂(YZ)Xₙ (IV)

where M is a Group 3 to 16 metal, preferably a Group 4 to 12 transition metal, and most preferably a Group 4, 5 or 6 transition metal; L^{D} is a bulky ligand that is bonded to M; each Q is independently bonded to M and Q₂(YZ) forms a unicharged polydentate ligand; A or Q is a univalent anionic ligand also bonded to M; X is a univalent anionic group when n is 2 or X is a divalent anionic group when n is 1;n is 1 or2.

In formula (IV), L and M are as defined above for formula (I). Q is as defined above for formula (I), preferably Q is selected from the group consisting of —O—, —NR—, —CR₂— and —S—; Y is either C or S; Z is selected from the group consisting of —OR, —NR₂, —CR₃, —SR, —SiR₃, —PR₂, —H, and substituted or unsubstituted aryl groups, with the proviso that when Q is —NR— then Z is selected from one of the group consisting of —OR, —NR₂, —SR, —SiR₃, —PR₂ and —H; R is selected from a group containing carbon, silicon, nitrogen, oxygen, and/or phosphorus, preferably where R is a hydrocarbon group containing from 1 to 20 carbon atoms, most preferably an alkyl, cycloalkyl, or an aryl group; n is an integer from 1 to 4, preferably 1 or 2; X is a univalent anionic group when n is 2 or X is a divalent anionic group when n is 1; preferably X is a carbamate, carboxylate, or other heteroallyl moiety described by the Q, Y and Z combination. In another embodiment of the invention, the bulky ligand metallocene-type catalyst compounds are heterocyclic ligand complexes where the bulky ligands, the ring(s) or ring system(s), include one or more heteroatoms or a combination thereof. Non-limiting examples of heteroatoms include a Group 13 to 16 element, preferably nitrogen, boron, sulfur, oxygen, aluminum, silicon, phosphorous and tin. Examples of these bulky ligand metallocene catalyst compounds are described in WO 96/33202, WO 96/34021, WO 97/17379 and WO 98/22486 and EP-A1-0 874 005 and U.S. Pat. Nos. 5,637,660, 5,539,124, 5,554,775, 5,756,611, 5,233,049, 5,744,417, and 5,856,258 all of which are herein incorporated by reference.

In another embodiment, the bulky ligand metallocene catalyst compounds are those complexes known as transition metal catalysts based on bidentate ligands containing pyridine or quinoline moieties, such as those described in U.S. application Ser. No. 09/103,620 filed Jun. 23, 1998, which is herein incorporated by reference. In another embodiment, the bulky ligand metallocene catalyst compounds are those described in PCT publications WO 99/01481 and WO 98/42664, which are fully incorporated herein by reference.

It is also contemplated that in one embodiment, the bulky ligand metallocene catalysts of the invention described above include their structural or optical or enantiomeric isomers (meso and racemic isomers, for example see U.S. Pat. No. 5,852,143, incorporated herein by reference) and mixtures thereof.

II. Activators

The catalyst composition of the invention also includes an activator compound, preferably a supported activator compound, and an activity enhancing ionizing activator compound also referred to herein as an activity promoter. For the purposes of this patent specification and appended claims, the term “activator” is defined to be any compound or component or method which can activate any of the catalyst compounds or combinations thereof of the invention for the polymerization of olefin(s).

A. Supported Activator

Many supported activators are described in various patents and publications which include: U.S. Pat. No. 5,728,855 directed to the forming a supported oligomeric alkylaluminoxane formed by treating a trialkylaluminum with carbon dioxide prior to hydrolysis; U.S. Pat. Nos. 5,831,109 and 5,777,143 discusses a supported methylalumoxane made using a non-hydrolytic process; U.S. Pat. No. 5,731,451 relates to a process for making a supported alumoxane by oxygenation with a trialkylsiloxy moiety; U.S. Pat. No. 5,856,255 discusses forming a supported auxiliary catalyst (alumoxane or organoboron compound) at elevated temperatures and pressures; U.S. Pat. No. 5,739,368 discusses a process of heat treating alumoxane and placing it on a support; EP-A-0 545 152 relates to adding a metallocene to a supported alumoxane and adding more methylalumoxane; U.S. Pat. Nos. 5,756,416 and 6,028,151 discuss a catalyst composition of a alumoxane impregnated support and a metallocene and a bulky aluminum alkyl and methylalumoxane; EP-B1-0 662 979 discusses the use of a metallocene with a catalyst support of silica reacted with alumoxane; PCT WO 96/16092 relates to a heated support treated with alumoxane and washing to remove unfixed alumoxane; U.S. Pat. Nos. 4,912,075, 4,937,301, 5,008,228, 5,086,025,5,147,949, 4,871,705, 5,229,478, 4,935,397, 4,937,217 and 5,057,475, and PCT WO 94/26793 all directed to adding a metallocene to a supported activator; U.S. Pat. No. 5,902,766 relates to a supported activator having a specified distribution of alumoxane on the silica particles; U.S. Pat. No. 5,468,702 relates to aging a supported activator and adding a metallocene; U.S. Pat. No. 5,968,864 discusses treating a solid with alumoxane and introducing a metallocene; EP 0 747 430 A1 relates to a process using a metallocene on a supported methylalumoxane and trimethylaluminum; EP 0 969 019 A1 discusses the use of a metallocene and a supported activator; EP-B2-0 170 059 relates to a polymerization process using a metallocene and a organo-aluminuim compound, which is formed by reacting aluminum trialkyl with a water containing support; U.S. Pat. No. 5,212,232 discusses the use of a supported alumoxane and a metallocene for producing styrene based polymers; U.S. Pat. No. 5,026,797 discusses a polymerization process using a solid component of a zirconium compound and a water-insoluble porous inorganic oxide preliminarily treated with alumoxane; U.S. Pat. No. 5,910,463 relates to a process for preparing a catalyst support by combining a dehydrated support material, an alumoxane and a polyfunctional organic crosslinker; U.S. Pat. Nos. 5,332,706, 5,473,028, 5,602,067 and 5,420,220 discusses a process for making a supported activator where the volume of alumoxane solution is less than the pore volume of the support material; WO 98/02246 discusses silica treated with a solution containing a source of aluminum and a metallocene; WO 99/03580 relates to the use of a supported alumoxane and a metallocene; EP-Al-0 953 581 discloses a heterogeneous catalytic system of a supported alumoxane and a metallocene; U.S. Pat. No. 5,015,749 discusses a process for preparing a polyhydrocarbyl-alumoxane using a porous organic or inorganic imbiber material; U.S. Pat. Nos. 5,446,001 and 5,534,474 relates to a process for preparing one or more alkylaluminoxanes immobilized on a solid, particulate inert support; and EP-A1-0 819 706 relates to a process for preparing a solid silica treated with alumoxane. Also, the following articles, also fully incorporated herein by reference for purposes of disclosing useful supported activators and methods for their preparation, include: W. Kaminsky, et al., “Polymerization of Styrene with Supported Half-Sandwich Complexes”, Journal of Polymer Science Vol. 37, 2959-2968 (1999) describes a process of adsorbing a methylalumoxane to a support followed by the adsorption of a metallocene; Junting Xu, et al. “Characterization of isotactic polypropylene prepared with dimethylsilyl bis(1-indenyl) zirconium dichloride supported on methylaluminoxane pretreated silica”, European Polymer Journal 35 (1999) 1289-1294, discusses the use of silica treated with methylalumoxane and a metallocene; Stephen O'Brien, et al., “EXAFS analysis of a chiral alkene polymerization catalyst incorporated in the mesoporous silicate MCM-41” Chem. Commun. 1905-1906 (1997) discloses an immobilized alumoxane on a modified mesoporous silica; and F. Bonini, et al., “Propylene Polymerization through Supported Metallocene/MAO Catalysts: Kinetic Analysis and Modeling” Journal of Polymer Science, Vol. 33 2393-2402 (1995) discusses using a methylalumoxane supported silica with a metallocene. Any of the methods discussed in these references are useful for producing the supported activator component utilized in the invention and all are incorporated herein by reference.

Also, combination of activators have described in for example, U.S. Pat. Nos. 5,153,157 and 5,453,410, European publication EP-B1 0 573 120, and PCT publications WO 94/07928 and WO 95/14044. These documents all discuss the use of an alumoxane and an ionizing activator with a bulky ligand metallocene catalyst compound.

In one embodiment, alumoxanes activators are used as a supported activator in the catalyst composition of the invention. Alumoxanes are generally oligomeric compounds containing —Al(R)—O— subunits, where R is an alkyl group. Examples of alumoxanes include methylalumoxane (MAO), modified methylalumoxane (MMAO), ethylalumoxane and isobutylalumoxane. Alumoxanes may be produced by the hydrolysis of the respective trialkylaluminum compound. MMAO may be produced by the hydrolysis of trimethylaluminum and a higher trialkylaluminum such as triisobutylaluminum. MMAO's are generally more soluble in aliphatic solvents and more stable during storage. A variety of methods for preparing alumoxanes and modified alumoxanes are described in U.S. Pat. Nos. 4,665,208, 4,952,540, 5,091,352, 5,206,199, 5,204,419, 4,874,734, 4,924,018, 4,908,463, 4,968,827, 5,041,584, 5,308,815, 5,329,032, 5,248,801, 5,235,081, 5,157,137, 5,103,031, 5,391,793, 5,391,529, 5,693,838, 5,731,253, 5,731,451, 5,744,656, 5,847,177, 5,854,166, 5,856,256 and 5,939,346 and European publications EP-A-0 561 476, EP-B1-0 279 586, EP-A-0 594-218 and EP-B1-0 586 665, and PCT publication WO 94/10180. Other alumoxanes include siloxy alumoxanes as described in EP-B1-0 621 279 and U.S. Pat. No. 6,060,418, and chemically functionalized carboxylate-alumoxane described in WO 00/09578, which are herein incorporated by reference.

Other activators useful in forming the supported activator utilized in the catalyst composition of the invention are aluminum alkyl compounds, such as trialkylaluminums and alkyl aluminum chlorides. Examples of these activators include trimethylaluminum, triethylaluminum, triisobutylaluminum, tri-n-hexylaluminum, tri-n-octylaluminum and the like.

The above-described activators may be combined with one or more support materials as described above or using one or more support methods known in the art. For example, in a most preferred embodiment, an activator is deposited on, contacted with, or incorporated within, vaporized onto, reacted with, adsorbed or absorbed in, or on, a support material.

The support material for forming the supported activator is any of the conventional support materials. Preferably the supported material is a porous support material, for example, talc, inorganic oxides and inorganic chlorides. Other support materials include resinous support materials such as polystyrene, functionalized or crosslinked organic supports, such as polystyrene divinyl benzene polyolefins or polymeric compounds, zeolites, clays, or any other organic or inorganic support material and the like, or mixtures thereof.

The preferred support materials are inorganic oxides that include those Group 2, 3, 4, 5, 13 or 14 metal oxides. The preferred support materials include silica, alumina, silica-alumina, magnesium chloride, and mixtures thereof. Other useful support materials include magnesia, titania, zirconia, montmorillonite (EP-B1 0 511 665), hydrotalcites, and the like. Also, combinations of these support materials may be used, for example, silica-chromium, silica-alumina, silica-titania and the like.

It is preferred that the support material, most preferably an inorganic oxide, has a surface area in the range of from about 10 to about 700 m²/g, pore volume in the range of from about 0.1 to about 4.0 cc/g and average particle size in the range of from about 5 to about 500 μm. More preferably, the surface area of the support material is in the range of from about 50 to about 500 m²/g, pore volume of from about 0.5 to about 3.5 cc/g and average particle size of from about 10 to about 200 μm. Most preferably the surface area of the support material is in the range is from about 100 to about 400 m²/g, pore volume from about 0.8 to about 3.0 cc/g and average particle size is from about 5 to about 100 μm. The average pore size of the carrier of the invention typically has pore size in the range of from 10 to 1000 Å, preferably 50 to about 500 Å, and most preferably 75 to about 350 Å.

The support materials may be treated chemically, for example with a fluoride compound as described in WO 00/12565, which is herein incorporated by reference. Other supported activators are described in for example WO 00/13792 that refers to supported boron containing solid acid complex.

In a preferred method of forming the supported activator the amount of liquid in which the activator is present is in an amount that is less than four times the pore volume of the support material, more preferably less than three times, even more preferably less than two times; preferred ranges being from 1.1 times to 3.5 times range and most preferably in the 1.2 to 3 times range. In an alternative embodiment, the amount of liquid in which the activator is present is from one to less than one times the pore volume of the support material utilized in forming the supported activator.

Procedures for measuring the total pore volume of a porous support are well known in the art. Details of one of these procedures is discussed in Volume 1, Experimental Methods in Catalytic Research (Academic Press, 1968) (specifically see pages 67-96). This preferred procedure involves the use of a classical BET apparatus for nitrogen absorption. Another method well known in the art is described in Innes, Total Porosity and Particle Density of Fluid Catalysts By Liquid Titration, Vol. 28, No. 3, Analytical Chemistry 332-334 (March, 1956).

In an embodiment, the supported activator is in a dried state or a solid. In another embodiment, the supported activator is in a substantially dry state or a slurry, preferably in a mineral oil slurry.

In another embodiment, two or more separately supported activators are used, or alternatively, two or more different activators on a single support are used.

B. Ionizing Activators

The catalyst composition of the invention also includes an ionizing activator which is acts as an activity enhancer. In one embodiment, the ionizing activator utilized in the catalyst composition includes a cation and an anion component, and may be represented by Formula VI below:

(L′-H)_{d}⁺(A^{d-}) (V)

wherein

L′ is an neutral Lewis base;

H is hydrogen;

(L′-H)⁺ is a Bronsted acid

A^{d-} is a non-coordinating anion having the charge d−

d is an integer from 1 to 3.

The cation component, (L′-H)_{d}⁺ may include Bronsted acids such as protons or protonated Lewis bases or reducible Lewis acids capable of protonating or abstracting a moiety, such as an akyl or aryl, from the bulky ligand metallocene catalyst compound, resulting in a cationic transition metal species.

In one embodiment the cation component (L′-H)_{d}⁺ includes ammoniums, oxoniums, phosphoniums, silyliums and mixtures thereof, preferably ammoniums of methylamine, aniline, dimethylamine, diethylamine, N-methylaniline, diphenylamine, trimethylamine, triethylamine, N,N-dimethylaniline, methyldiphenylamine, pyridine, p-bromo N,N-dimethylaniline, p-nitro-N,N-dimethylaniline, phosphoniums from triethylphosphine, triphenylphosphine, and diphenylphosphine, oxomiuns from ethers such as dimethyl ether diethyl ether, tetrahydrofuran and dioxane, sulfoniums from thioethers, such as diethyl thioethers and tetrahydrothiophene and mixtures thereof. In a preferred embodiment, the cation component (L′-H)_{d}⁺ of the ionizing activator is dimethylanaline.

In another embodiment cation component (L′-H)_{d}⁺ may also be an abstracting moiety such as silver, carboniums, tropylium, carbeniums, ferroceniums and mixtures, preferably carboniums and ferroceniums. In a preferred embodiment, the cation component (L′-H)_{d}⁺ of the ionizing activator is triphenyl carbonium.

In another embodiment, the anion component A^{d-} of the ionizing activator includes those anions having the formula [M^{k+}Qₙ]^{d-} wherein k is an integer from 1 to 3; n is an integer from 2-6; n−k=d; M is an element selected from Group 13 of the Periodic Table of the Elements and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, with Q having up to 20 carbon atoms with the proviso that in not more than 1 occurrence is Q a halide. In a preferred embodiment, each Q is a fluorinated hydrocarbyl group having 1 to 20 carbon atoms, more preferably each Q is a fluorinated aryl group, and most preferably each Q is a pentafluoryl aryl group.

In another embodiment, the anion component A^{d-} of the ionizing activator may also include diboron compounds as disclosed in U.S. Pat. No. 5,447,895, which is fully incorporated herein by reference.

In another embodiment the ionizing activator or activity promoter is a tri-substituted boron, tellurium, aluminum, gallium, or indium compound or mixtures thereof. The three substituent groups are each independently selected from alkyls, alkenyls, halogen, substituted alkyls, aryls arylhalides, alkoxy and halides. Preferably, the three groups are independently selected from halogen, mono or multicyclic (including halosubstituted) aryls, alkyls, and alkenyl compounds and mixtures thereof, preferred are alkenyl groups having 1 to 20 carbon atoms, alkyl groups having 1 to 20 carbon atoms, alkoxy groups having 1 to 20 carbon atoms and aryl groups having 3 to 20 carbon atoms (including substituted aryls). In another embodiment, the three groups are alkyls having 1 to 4 carbon groups, phenyl, napthyl or mixtures thereof. In another embodiment each of the three substituent groups is a fluorinated hydrocarbyl group having 1 to 20 carbon atoms, preferably a fluorinated aryl group, and more preferably a pentafluoryl aryl group. In another embodiment the ionizing activator is trisperfluorophenyl boron or trisperfluoronapthyl boron.

In another embodiment the ionizing activator or activity promoter is an organometallic compound such as the Group 13 organometallic compounds of U.S. Pat. Nos. 5,198,401, 5,278,119, 5,407,884, 5,599,761 5,153,157, 5,241,025, and WO-A-93/14132, WO-A-94/07927, and WO-A-95/07941, all documents are incorporated herein by reference.

In another embodiment, the ionizing activator is selected from tris(pentafluorophenyl)borane (BF-15), dimethylanilinium tetra(pentafluoro-phenyl)borate (BF-20), dimethylanilinium tetra(pentafluorophenyl)aluminate, dimethylanilinium tetrafluoroaluminate, tri(n-butyl)ammonium) tetra(pentafluorophenyl)borate, tri(n-butyl)ammonium) tetra(pentafluorophenyl)-aluminate, tri(n-butyl)ammonium) tetrafluoroaluminate, the sodium, potassium, lithium, tropyliun and the triphenylcarbenium salts of these compounds, or from combinations thereof. In preferred embodiment, the ionizing activator is N,N-dimethylanilinium tetra(perfluorophenyl)borate or triphenylcarbenium tetra(perfluorophenyl)borate.

In one embodiment of the invention, the activity of the catalyst system is increased at least 200%, preferably at least 300%, more preferably at least 400%, more preferably at least 500%, more preferably 600%, more preferably at least 700%, more preferably at least 800%, more preferably at least 900%, or more preferably at least 1000% relative to the activity of the same catalyst system to which no ionizing activator has been added.

In one embodiment, the ionizing activator is added in an amount necessary to effect an increase in the catalyst systems activity. In another embodiment, the molar ratio of the ionizing activator to the metal contained in the bulky ligand metallocene catalyst compound is about 0.01 to 100, preferably about 0.01 to 10, more preferably 0.05 to 5 and even more preferably 0.1 to 2.0.

III. Cycloalkadienyl Modifier

The activity of the catalyst composition of the invention may be further enhanced by the optional addition of a cycloalkadiene compound. A cycloalkadiene is an organocyclic compound having two or more conjugated double bonds, examples of which include cyclic hydrocarbon compounds having 2 to 4 conjugated double bonds and 4 to 24, preferably 4 to 12, carbons atoms. The cycloalkadiene may optionally be substituted with a group such as alkyl or aryl of 1 to 12 carbon atoms.

Examples of activity enhancing cycloalkadienes include unsubstituted and substituted cyclopentadienes, indenes, fluorenes, and fulvenes, such as cyclopentadiene, methylcyclopentadiene, ethylcyclopentadiene, t-butylcyclopentadiene, hexylcyclopentadiene, octylcyclopentadiene, 1,2-dimethylcyclopentadiene, 1,3-dimethylcyclopentadiene, 1,2,4-trimethylcyclo-pentadiene, 1,2,3,4-tetramethylcyclopentadiene, pentamethylcyclopentadiene, indene, 4-methyl-1-indene, 4,7-dimethylindene, 4,5,6,7-tetrahydroindene, fluorene, methylfluorene, cycloheptatriene, methylcycloheptatriene, cyclooctatraene, methylcyclooctatraene, fulvene and dimethylfulvene. These compounds may be bonded through an alkylene group of 2-8, preferably 2-3, carbon atoms, such as for example bis-indenylethane, bis(4,5,6,7-tetrahydro-1-indenyl)ethane, 1,3-propanedinyl-bis(4,5,6,7-tetrahydro)indene, propylene-bis(1-indene), isopropyl(1-indenyl) cyclopentadiene, diphenylmethylene(9-fluorenyl), cyclopentadiene and isopropylcyclopentadienyl-1-fluorene. Preferred cycloalkydienes are the 1,3-type dienes such cyclopentadiene and indene.

In one embodiment of the invention, the activity of the catalyst system is increased at least 200%, more preferably at least 400%, more preferably 600%, more preferably at least 700%, more preferably at least 800%, more preferably at least 900%, or more preferably at least 1000% relative to the activity of the same catalyst system to which no modifier has been added.

In one embodiment, the cycloalkadiene modifier is added in an amount necessary to effect an increase in the catalyst systems activity. In another embodiment, the molar ratio of the cycloalkadiene modifier to the metal contained in the bulky ligand metallocene catalyst compound is about 0.01 to 100, preferably about 0.01 to 10, more preferably about 0.05 to 5, and even more preferably 0.1 to 2.0.

IV. Catalyst Compositions

The catalyst compositions of the invention are formed in various ways. In one embodiment, a supported activator is combined with a bulky ligand metallocene catalyst compound and an ionizing activator. Preferably in this embodiment, the catalyst composition is formed in mineral oil. Optionally, a cycloalkadiene compound is added to further enhance the activity of the catalyst composition.

In another embodiment, the resulting mixture of the combination of the supported activator, a bulky ligand metallocene catalyst compound and the ionizing activator is stirred for a period of time and at a specified temperature. In one embodiment, the mixing time is in the range of from 1 minute to several days, preferably about one hour to about a day, more preferably from about 2 hours to about 20 hours, and most preferably from about 5 hours to about 16 hours. The period of contacting refers to the mixing time only.

The mixing temperature ranges from −60° C. to about 200° C., preferably from 0° C. to about 100° C., more preferably from about 10° C. to about 60° C., still more preferably from 20° C. to about 40° C., and most preferably at room temperature.

In general, the bulky ligand metallocene catalyst compound and supported activator, for example in the preferred embodiment, where the supported activator is a supported aluminum compound, most preferably alumoxane, the ratio of aluminum atom to catalyst transition metal atom is about 1000:1 to about 1:1. preferably a ratio of about 300:1 to about 1:1, and more preferably about 50:1 to about 250:1, and most preferably from 100:1 to 125:1.

In another embodiment, the ionizing activator compound is utilized in a quantity that provides a mole ratio of the ionizing activator to the catalyst transition metal atom of from about 0.01 to 1.0, preferably from about 0.1 to about 0.9, more preferably from 0.2 to about 0.8 and most preferably from about 0.3 to 0.7.

In another embodiment the combined amount in weight percent of the supported activator to the bulky ligand metallocene catalyst compound and the ionizing compound are in the range of from 99.9 weight percent to 50 weight percent, preferably from about 99.8 weight percent to about 60 weight percent, more preferably from about 99.7 weight percent to about 70 weight percent, and most preferably from about 99.6 weight percent to about 80 weight percent. In other embodiments of the invention the supported activator is in a dry or substantially dried state, or in a solution, when contacted with the bulky ligand metallocene catalyst compound and the ionizing activator. The resulting catalyst composition is used in a dry or substantially dry state, or as a slurry, in preferably a mineral oil. Also, the dried catalyst composition of the invention can be reslurried in a liquid such as mineral oil, toluene, or any the hydrocarbon prior to its introduction into a polymerization reactor.

Furthermore, it is contemplated that the supported activator, the bulky ligand metallocene catalyst compound, and the ionizing activator can be used in the same solvents or different solvents. For example, the catalyst compound can be in toluene, the ionizing activator compound in isopentane, and the supported activator in mineral oil, or any combination of solvents. In the most preferred embodiment, the solvent is the same and is a mineral oil.

Antistatic agents or surface modifiers may be used in combination with the supported activator, bulky ligand metallocene catalyst compound and ionizing activator, see for example those agents and modifiers described in PCT publication WO 96/11960, which is herein fully incorporated by reference. Also, a carboxylic acid salt of a metal ester, for example aluminum carboxylates such as aluminum mono, di- and tri-stearates, aluminum octoates, oleates and cyclohexylbutyrates, as described in U.S. application Ser. No. 09/113,216, filed Jul. 10, 1998 may be used in combination with a supported activator, bulky ligand metallocene catalyst compound and ionizing activator.

In one embodiment of the invention, olefin(s), preferably C₂ to C₃₀ olefin(s) or alpha-olefin(s), preferably ethylene or propylene or combinations thereof are prepolymerized in the presence of the supported activator, bulky ligand metallocene catalyst compound and ionizing activator combination prior to the main polymerization. The prepolymerization can be carried out batchwise or continuously in gas, solution or slurry phase including at elevated pressures. The prepolymerization can take place with any olefin monomer or combination and/or in the presence of any molecular weight controlling agent such as hydrogen. For examples of prepolymerization procedures, see U.S. Pat. Nos. 4,748,221, 4,789,359, 4,923,833, 4,921,825, 5,283,278 and 5,705,578 and European Publication EP-B1-0 279 863 and PCT Publication WO 97/44371, and all of which are herein fully incorporated by reference.

In one embodiment, the ionizing activator, the bulky ligand metallocene catalyst compound, silica supported MAO and optionally a cycloalkadiene compound such as for example indene or 1,2-bis(3-indenyl)ethane are all combined in mineral oil. The resulting mixture is then stirred at room temperature before being employed for polymerization.

In another embodiment, the ionizing activator is directly combined with a mineral oil slurry of a supported bulky ligand metallocene catalyst compound.

In another embodiment, a solution of the ionizing activator in toluene is combined with a mineral oil slurry of a supported bulky ligand metallocene catalyst compound.

In another embodiment, a slurry of the ionizing activator and a supported bulky ligand metallocene catalyst compound is prepared in toluene. The mixture is stirred at room temperature then the toluene is removed under vacuum with mild heating which results in a free-flowing powder which is used directly or added to mineral oil and fed as a slurry.

In another embodiment, the amount of ionizing activator, combined with the bulky ligand metallocene catalyst supported with an alumoxane, is comparable to that of the bulky ligand metallocene catalyst. For example, a BF-20/Zr ratio of from about 0.01 to about 100, or more preferably from about 0.05 to about 5, or even more preferably from about 0.05 to about 3 is used.

In another embodiment, the method for introducing the ionizing activator into the supported catalyst system involves the use of a high boiling point, viscous hydrocarbon as the liquid diluent. The diluents of this invention preferably have high boiling points which are usually above 400° F. (204° C.), a flash point of greater than 200° F. (93.3° C.). Examples of these liquids include white mineral oil such as Kaydol, available from Witco, Inc., Memphis Tenn., and other mineral oils. These diluents are advantageous because they do not change in volume upon heating so that the concentration of the solutes will remain constant during the preparation. Also, washing or decanting steps are not required, and the prepared catalyst composition can be transferred directly to the reaction chamber, without solvent removal, as a slurry. In addition to the removal of a step from the preparation process, the use of a high boiling point solvent can be used to protect the catalyst system from environmental effects with are known to decrease catalyst activity. Another advantage in the use of a high boiling point solvent is that these liquids are more viscous than typical hydrocarbons, and can keep the supported catalyst suspended. A well-suspended catalyst provides a more homogeneous composition which is essential for smoother reactor operation and tighter product control. The high viscosity of these liquids is also important in that diffusion of air and water through the liquid is slower than diffusion in less viscous liquids, which results in lower occurrence of air and water poisoning the catalyst. Furthermore, the metallocene or metallocene catalysts of this invention do not have to be soluble in the high boiling point solvent. Interaction of this compound with supported MAO at the interface is normally strong enough to form an activated system for anchoring on the support.

In another embodiment, the method for introducing the ionizing activator into the supported catalyst system does not require heat. In another embodiment, heat can be used, especially if it is important to speed up the reaction.

Because, BF-20, for example, is only sparingly soluble in mineral oil, most of the compound will sit on top of the solution and will only gradually mix in with the supported metallocene. This slow mixing of borate into the solution allows for a unique adsorption isotherm for borate adsorption onto the support. This process gives a more homogenous distribution of the components on the catalyst support than can be obtained by the more usual method of using toluene for adding modifiers to a catalyst system.

V. Polymerization Process

The catalyst compositions of the invention described above are suitable for use in any polymerization process over a wide range of temperatures and pressures. The temperatures may be in the range of from −60° C. to about 280° C., preferably from 50° C. to about 200° C., and the pressures employed may be in the range from 1 atmosphere to about 500 atmospheres or higher.

Polymerization processes include solution, gas phase, slurry phase and a high pressure process or a combination thereof. Particularly preferred is a gas phase or slurry phase polymerization of one or more olefins at least one of which is ethylene or propylene.

In one embodiment, the catalyst composition of the invention is utilized in a solution, high pressure, slurry or gas phase polymerization process of one or more olefin monomers having from 2 to 30 carbon atoms, preferably 2 to 12 carbon atoms, and more preferably 2 to 8 carbon atoms. Polyolefins that can be produced using these catalyst systems include, but are not limited to, homopolymers, copolymers and terpolymers of ethylene and higher alpha-olefins containing 3 to about 12 carbon atoms, such as propylene, 1-butene, 1-pentene, 1-hexene, 4-methyl-1-pentene, and 1-octene, with densities ranging from about 0.86 to about 0.97; polypropylene; ethylene/propylene rubbers (EPR's); ethylene/propylene/diene terpolymers (EPDM's); and the like.

Other monomers useful in polymerization processes utilizing the catalyst composition of the invention include ethylenically unsaturated monomers, diolefins having 4 to 18 carbon atoms, conjugated or nonconjugated dienes, polyenes, vinyl monomers and cyclic olefins. Non-limiting monomers useful in the invention may include norbomene, norbornadiene, isobutylene, isoprene, vinylbenzocyclobutane, styrenes, alkyl substituted styrene, ethylidene norbornene, dicyclopentadiene and cyclopentene.

In a preferred embodiment, the catalyst composition of the invention is utilized in a polymerization process where a copolymer of ethylene is produced, where with ethylene, a comonomer having at least one alpha-olefin having from 4 to 15 carbon atoms, preferably from 4 to 12 carbon atoms, and most preferably from 4 to 8 carbon atoms, is polymerized in a gas phase process.

Typically in a gas phase polymerization process a continuous cycle is employed wherein one part of the cycle of a reactor system, a cycling gas stream, otherwise known as a recycle stream or fluidizing medium, is heated in the reactor by the heat of polymerization. This heat is removed from the recycle composition in another part of the cycle by a cooling system external to the reactor. Generally, in a gas fluidized bed process for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer. (See for example U.S. Pat. Nos. 4,543,399, 4,588,790, 5,028,670, 5,317,036, 5,352,749, 5,405,922, 5,436,304, 5,453,471, 5,462,999, 5,616,661 and 5,668,228, all of which are fully incorporated herein by reference.)

The reactor pressure in a gas phase process may vary from about 60 psig (690 kPa) to about 500 psig (3448 kPa), preferably in the range of from about 200 psig (1379 kPa) to about 400 psig (2759 kPa), more preferably in the range of from about 250 psig (1724 kPa) to about 350 psig (2414 kPa).

The reactor temperature in a gas phase process may vary from about 30° C. to about 120° C., preferably from about 60° C. to about 115° C., more preferably in the range of from about 70° C. to 110° C., and most preferably in the range of from about 70° C. to about 95° C.

Other gas phase processes contemplated by the process of the invention include series or multistage polymerization processes. Also gas phase processes contemplated by the invention include those described in U.S. Pat. Nos. 5,627,242, 5,665,818 and 5,677,375, and European publications EP-A-0 794 200 EP-B1-0 649 992, EP-A-0 802 202 and EP-B-634 421 all of which are herein fully incorporated by reference.

In a preferred embodiment, the reactor utilized is capable and the process of the invention is producing greater than 500 lbs of polymer per hour (227 Kg/hr) to about 200,000 lbs/hr (90,900 Kg/hr) or higher of polymer, preferably greater than 1000 lbs/hr (455 Kg/hr), more preferably greater than 10,000 lbs/hr (4540 Kg/hr), even more preferably greater than 25,000 lbs/hr (11,300 Kg/hr), still more preferably greater than 35,000 lbs/hr (15,900 Kg/hr), still even more preferably greater than 50,000 lbs/hr (22,700 Kg/hr) and most preferably greater than 65,000 lbs/hr (29,000 Kg/hr) to greater than 100,000 lbs/hr (45,500 Kg/hr).

A slurry polymerization process generally uses pressures in the range of from about 1 to about 50 atmospheres and even greater and temperatures in the range of 0° C. to about 120° C. In a slurry polymerization, a suspension of solid, particulate polymer is formed in a liquid polymerization diluent medium to which ethylene and comonomers and often hydrogen along with catalyst are added. The suspension including diluent is intermittently or continuously removed from the reactor where the volatile components are separated from the polymer and recycled, optionally after a distillation, to the reactor. The liquid diluent employed in the polymerization medium is typically an alkane having from 3 to 7 carbon atoms, preferably a branched alkane. The medium employed should be liquid under the conditions of polymerization and relatively inert. When a propane medium is used the process must be operated above the reaction diluent critical temperature and pressure. Preferably, a hexane or an isobutane medium is employed.

A preferred polymerization technique, where the catalyst composition of the invention maybe be utilized, is referred to as a particle form polymerization, or a slurry process where the temperature is kept below the temperature at which the polymer goes into solution. Such technique is well known in the art, and described in for instance U.S. Pat. No. 3,248,179 which is fully incorporated herein by reference. Other slurry processes include those employing a loop reactor and those utilizing a plurality of stirred reactors in series, parallel, or combinations thereof. Non-limiting examples of slurry processes include continuous loop or stirred tank processes. Also, other examples of slurry processes are described in U.S. Pat. No. 4,613,484, which is herein fully incorporated by reference.

In an embodiment the reactor used in the slurry process is capable of and the process of the invention is producing greater than 2000 lbs of polymer per hour (907 Kg/hr), more preferably greater than 5000 lbs/hr (2268 Kg/hr), and most preferably greater than 10,000 lbs/hr (4540 Kg/hr). In another embodiment the slurry reactor used in the process of the invention is producing greater than 15,000 lbs of polymer per hour (6804 Kg/hr), preferably greater than 25,000 lbs/hr (11,340 Kg/hr) to about 100,000 lbs/hr (45,500 Kg/hr).

Examples of solution processes are described in U.S. Pat. Nos. 4,271,060, 5,001,205, 5,236,998 and 5,589,555, which are fully incorporated herein by reference.

A preferred process is where the process, preferably a slurry or gas phase process is operated in the presence of a bulky ligand metallocene catalyst composition of the invention and in the absence of or essentially free of any scavengers, such as triethylaluminum, trimethylaluminum, tri-isobutylaluminum and tri-n-hexylaluminum and diethyl aluminum chloride, dibutyl zinc and the like. This preferred process is described in PCT publication WO 96/08520 and U.S. Pat. Nos. 5,712,352 and 5,763,543, which are herein fully incorporated by reference.

VI. Polymer Products

The polymers produced by the process of the invention can be used in a wide variety of products and end-use applications. The polymers produced by the process of the invention include linear low-density polyethylene, elastomers, plastomers, high-density polyethylenes, low-density polyethylenes, polypropylene and polypropylene copolymers.

The polymers, typically ethylene based polymers, have a density in the range of from 0.86 g/cc to 0.97 g/cc, preferably in the range of from 0.88 g/cc to 0.965 g/cc, more preferably in the range of from 0.900 g/cc to 0.96 g/cc, even more preferably in the range of from 0.905 g/cc to 0.95 g/cc, yet even more preferably in the range from 0.910 g/cc to 0.940 g/cc, and most preferably greater than 0.915 g/cc, preferably greater than 0.920 g/cc, and most preferably greater than 0.925 g/cc. Density is measured in accordance with ASTM-D-1238.

The polymers produced by the process of the invention typically have a molecular weight distribution, a weight average molecular weight to number average molecular weight (M_{w}/Mₙ) of greater than 1.5 to about 15, particularly greater than 2 to about 10, more preferably greater than about 2.2 to less than about 8, and most preferably from 2.5 to 8.

Also, the polymers of the invention typically have a narrow composition distribution as measured by Composition Distribution Breadth Index (CDBI). Further details of determining the CDBI of a copolymer are known to those skilled in the art. See, for example, PCT patent application WO 93/03093, published Feb. 18, 1993, which is fully incorporated herein by reference.

The bulky ligand metallocene catalyzed polymers of the invention in one embodiment have CDBI's generally in the range of greater than 50% to 100%, preferably 99%, preferably in the range of 55% to 85%, and more preferably 60% to 80%, even more preferably greater than 60%, still even more preferably greater than 65%.

In another embodiment, polymers produced using a bulky ligand metallocene catalyst system of the invention have a CDBI less than 50%, more preferably less than 40%, and most preferably less than 30%.

The polymers of the present invention in one embodiment have a melt index (MI) or (I₂) as measured by ASTM-D-1238-E in the range from 0.01 dg/min to 1000 dg/min, more preferably from about 0.01 dg/min to about 100 dg/min, even more preferably from about 0.1 dg/min to about 50 dg/min, and most preferably from about 0.1 dg/min to about 10 dg/min.

The polymers of the invention in an embodiment have a melt index ratio (I₂₁/I₂) (I₂₁ is measured by ASTM-D-1238-F) of from 10 to less than 25, more preferably from about 15 to less than 25.

The polymers of the invention in a preferred embodiment have a melt index ratio (I₂₁/I₂) (I₂₁ is measured by ASTM-D-1238-F) of from preferably greater than 25, more preferably greater than 30, even more preferably greater that 40, still even more preferably greater than 50 and most preferably greater than 65. In an embodiment, the polymer of the invention may have a narrow molecular weight distribution and a broad composition distribution or vice-versa, and may be those polymers described in U.S. Pat. No. 5,798,427 incorporated herein by reference.

In yet another embodiment, propylene based polymers are produced in the process of the invention. These polymers include atactic polypropylene, isotactic polypropylene, hemi-isotactic and syndiotactic polypropylene. Other propylene polymers include propylene block or impact copolymers. Propylene polymers of these types are well known in the art see for example U.S. Pat. Nos. 4,794,096, 3,248,455, 4,376,851, 5,036,034 and 5,459,117, all of which are herein incorporated by reference.

The polymers of the invention may be blended and/or coextruded with any other polymer. Non-limiting examples of other polymers include linear low density polyethylenes produced via conventional Ziegler-Natta and/or bulky ligand metallocene catalysis, elastomers, plastomers, high pressure low density polyethylene, high density polyethylenes, polypropylenes and the like.

Polymers produced by the process of the invention and blends thereof are useful in such forming operations as film, sheet, and fiber extrusion and co-extrusion as well as blow molding, injection molding and rotary molding. Films include blown or cast films formed by coextrusion or by lamination useful as shrink film, cling film, stretch film, sealing films, oriented films, snack packaging, heavy duty bags, grocery sacks, baked and frozen food packaging, medical packaging, industrial liners, membranes, etc. in food-contact and non-food contact applications. Fibers include melt spinning, solution spinning and melt blown fiber operations for use in woven or non-woven form to make filters, diaper fabrics, medical garments, geotextiles, etc. Extruded articles include medical tubing, wire and cable coatings, geomembranes, and pond liners. Molded articles include single and multi-layered constructions in the form of bottles, tanks, large hollow articles, rigid food containers and toys, etc.

### EXAMPLES

In order to provide a better understanding of the present invention including representative advantages thereof, the following examples are offered.

As used herein, methylalumoxane is MAO, silica supported MAO is SMAO, dimethylanilinium tetra(pentafluorophenyl)borate is BF-20, tris(pentafluorophenyl)borane is BF-15, Catalyst Component A is 1,3-dimethylcyclopentadienylzirconium trispivalate, Catalyst Component B is indenylzirconium trispivalate, Catalyst Component C is bis(1,3-methyl-n-butylcyclopentadienyl)zirconium dichloride and Catalyst Component D is dimethylsilylbis(tetrahydroindenyl)zirconium dichloride. Catalyst components C and D are available from Albemarle Corporation, Baton Rouge, La.

Activity values are normalized values based upon grams of polymer produced per mmol of transition metal in the catalyst per hour per 100 psi (689KPa) of ethylene polymerization pressure.

Melt Index, (MI) is reported as grams per 10 minutes and is calculated using ASTM D-1238, Condition E.

Flow Index, (FI) was measured utilizing ASTM D-1238, Condition F.

¹H NMR spectra were measured by a Bruker AMX 300

### Example 1

Preparation of Supported Activator

A toluene solution of methylalumoxane (MAO) was prepared by mixing 960 g of 30 wt % MAO, purchased from Albemarle Corporation, Baton Rouge, La., in 2.7 liter of dry, degassed toluene. The solution was stirred at ambient temperature while 850 g of silica gel (Davison 955, dehydrated at 600° C.) was added. The resulting slurry was stirred at ambient temperature for 1 hour and the solvent was removed under reduced pressure with a stream of nitrogen at 85° C. The drying continued until the material temperature remained constant for 2 hours. The resulting free-flowing white powder has an aluminum loading of 4.1 mmol Al per gram of solid.

### Example 2

Synthesis of Catalyst Component A (1,3-Dimethylcyclopentadienyl)zirconium trispivalate

To a solution of bis(1,3-dimethylcyclopentadienyl)zirconium dichloride (1.390 g, 3.99 mmol) and pivalic acid (1.520 g, 14.9 mmol) in toluene at 25° C. neat triethylamine (1.815 g, 18.10 mmol) was added with stirring. A white precipitate formed immediately which was removed by filtration. The compound was isolated as a pale-yellow powder in 88% yield and exhibited a purity above 99% based on NMR results. ¹H NMR (toluene-d₈): δ5.84 (m, 2H), 5.53 (m, 1H), 2.18 (s, 6H), 1.13 (s, 27H).

### Example 3

Synthesis of Catalyst Component B (Indenylzirconium Trisipivalate)

The compound (Ind)Zr(NEt₂)₃ (37 mg, 0.088 mmole) was dissolved in 1.0 mL of benzene-d6. A solution of pivalic acid (27 mg, 0.26 mmole) in 1.0 mL benzene-d6 was added with stirring. ¹H NMR exhibited resonances assigned to NEt₂ H and (Ind)Zr(O₂ CCMe₃)₃. ¹H NMR (C₆ D₆) d 7.41 (AA′BB′, indenyl, 2H), 6.95 (AA′BB′, indenyl, 2H), 6.74 (t, J=3.3 Hz, 2-indenyl, 1H), 6.39 (d, J=3.3 Hz, 1-indenyl, 2H), 1.10 (s, CH₃, 27H).

### Example 4

Preparation of Catalyst Systems I, II, and III using Catalyst Component A Catalyst System I

A solution of MAO and toluene was prepared by combining 900 grams of 30 wt % MAO in toluene and 850 grams of dry toluene at ambient temperature. A solution of Catalyst A in toluene is prepared (12 grams Catalyst A in about 200 grams toluene). The Catalyst Component A completely dissolved. This solution was then added to the MAO/toluene solution and mixed for 3 hours at ambient temperature to allow the MAO activation to occur. 500 grams of Davison 955 silica dehydrated at 600° C. (Davison 955 is available from W. R. Grace, Davison Division, Baltimore, Md.) were then added. The silica slurry was allowed to mix overnight at ambient temperature. The slurry was dried by heating the jacket to 100-110° C. and reducing the pressure to 380 mm Hg. The slurry temperature was held at 85 ° C. at this pressure while the free solvent boiled off. When the slurry has concentrated into a mud, the pressure was further reduced to 250 mm Hg and a nitrogen sweep through the solids was started. These conditions were held until the material temperature remained constant for 3 hours. The line out temperature is typically 90 to 95° C. The dried catalyst is then cooled and discharged. The dry material flows easily and about 700 g was collected. The yield was about 90%.

Catalysts Systems II

In the preparation of Catalyst System II, Catalyst System I was prepared as described above. Catalyst System I was then reslurried in isopentane (about 5 cc/g of catalyst). About 4.5 grams of indene dissolved in isopentane was added. The catalyst slurry was mixed for 1 hour in the presence of the indene. Drying was then started by heating the jacket to 60 ° C. with the mix tank at 5 psig. The material temperature held at 40° C. while the free solvent evaporated, and then slowly increased towards the jacket temperature as the mud became a free flowing powder. A nitrogen sweep was started once the slurry had concentrated into a mud. These conditions were held until the material temperature reached 50° C. The catalyst was then cooled and discharged.

Catalysts Systems III

In the preparation of Catalyst System III, the preparation for Catalyst System I is utilized except that indene was added to the toluene solution of Catalyst Component A.

Loadings

The average zirconium loading, as measured by ICP, for supported Catalyst Component A systems is 0.035 mmole zirconium per gram of solid catalyst (Table 1). The aluminum content for supported systems is about 6 mmole per gram of solid catalyst. These loadings give an Al (MAO)/Zr ratio of about 180. Scanning Electronic Microscopy (SEM) mapping studies indicated that the aluminum was evenly dispersed across the silica particle.

TABLE 1
ICP Results for Zirconium and Aluminum of
Catalyst Systems I, II and III

| | Zr Loading | Al Loading | | | |
|---|---|---|---|---|---|
| Catalyst No. | (mmol/g) | (mmol/g) | Al/Zr | Si (wt%) | Indene/Zr |
| Catalyst I | 0.033 | 5.35 | 162 | 29 | 0 |
| Catalyst II | 0.033 | 5.45 | 165 | 33 | 1.5 |
| Catalyst III | 0.035 | 6.48 | 185 | 27 | 1.5 |

### Example 5

Preparation of Catalyst System IV Using Catalyst Component B

4.50 g of silica supported MAO was added to a mineral oil solution of indenylzirconium trispivalate (Catalyst Component B, 0.090 g, 0.177 mmol). The resulting mixture was then stirred for 16 hours at room temperature before being used for polymerization.

### Example 6

Preparation of Catalyst V Using Catalyst Component C

Catalyst component C is bis(1,3-methyl-n-butylcyclopentadienyl)zirconium dichloride. A 2 gallon (7.57 liters) reactor was charged with 1060 g of 30% MAO in toluene, followed by 1.5 liter of toluene. While stirring, 23.1 g of Catalyst Component C as an 8% solution in toluene was added to the reactor. The mixture was stirred for 60 minutes at room temperature to form a catalyst solution. The content of the reactor was unloaded to a flask and 850 g of Davison 948 silica dehydrated at 600° C. was charged to the reactor. The catalyst solution contained in the flask then added slowly to the silica in the reactor while agitating slowly. More toluene (350 cc) was added to ensure a slurry consistency and the mixture was stirred for an additional 20 min. 6 g of Kemamine AS-990 (available from Witco Corporation, Memphis, Tenn.) as a 10% solution in toluene was added and stirring continued for 30 min. at room temperature. The temperature was then raised to 68° C. (155° F.) and vacuum was applied in order to dry the polymerization catalyst. Drying was continued for approximately 6 hours at low agitation until the polymerization catalyst appeared to be free flowing. It was then discharged into a flask and stored under a nitrogen atmosphere. The yield was 1060 g due to some losses in the drying process. Analysis of the polymerization catalyst was: Zr=0.40 wt %, Al=12 wt %, Al/Zr=101.

### Example 7

Preparation of Catalyst VI Using Catalyst V

To a solution of bis(1,3-methyl-n-butylcyclopentadienyl)zirconium dichloride (0.018 g, 0.0417 mmol) in mineral oil (Kaydol, 27 ml) was added 1.025 g of Catalyst V prepared above. The resulting slurry was then stirred at room temperature for 16 hours before being employed for polymerization.

### Example 8

Preparation of Catalyst VII Using Catalyst Component D

Catalyst Component D is dimethylsilylbis (tetrahydroindenyl)zirconium dichloride. A typical preparation of the polymerization catalyst used in the Examples below is as follows: 460 lbs (209 Kg) of sparged and dried toluene is added to an agitated reactor after which 1060 lbs (482 Kg) of a 30 wt % MAO in toluene is added. 947 lbs (430 Kg) of a 2 wt % toluene solution of Catalyst Component D and 600 lbs (272 Kg) of additional toluene are introduced into the reactor. This mixture is then stirred at 80-100° F. (26.7° C. to 36.8° C.) for one hour. While stirring the above solution, 850 lbs (386 Kg) of 600° C. Crosfield dehydrated silica (available from Corsfield Limited, Warrington, England) is added slowly to the solution and the mixture agitated for 30 min. at 80° F. to 100° F. (26.7° C. to 37.8° C.). At the end of the 30 min. agitation of the mixture, 240 lbs (109 Kg) of a 10 wt % toluene solution of AS-990 Kemamine (available from Witco Corporation, Memphis, Tenn.) is added together with an additional 110 lbs (50 Kg) of a toluene rinse and the reactor contents then is mixed for 30 min. while heating to 175° F. (79° C.). After 30 min. vacuum is applied and the polymerization catalyst dried at 175° F. (79° C.) for about 15 hours to a free flowing powder. The final polymerization catalyst weight was 1200 lbs (544 Kg) and has a Zr wt % of 0.35 and an Al wt % of 12.0.

### Example 9

Preparation of Catalyst VIII Using Catalyst Component A, 1,2-Bis(3-Indenyl)ethane, and SMAO in Kaydol Oil

To a mineral oil solution of 1,3-dimethylcyclopentadienylzirconium trispivalate (Catalyst Component A, 0.095 g, 0.195 mmol in 35 ml of Kaydol oil) were added SMAO (5.40 g) and 1,2-bis(3-indenyl)ethane (0.025g, 0.0967 mmol). The resulting mixture was then stirred for 16 hours at room temperature before being used for polymerization.

### Example 10

Polymerization Process

In each of the Runs 1 to 20 and in each of the Comparative Runs C1 to C8, polyethylene was produced in a slurry phase reactor. The catalyst composition utilized and the activity is specified in Table 2. For each of Runs 1 to 20, a slurry of one of the borate or boron treated catalyst system illustrative of the invention was prepared using one of the four specific methods described below. An aliquot of this slurry mixture was added to an 8 ounce (250 ml) bottle containing 100 ml of hexane. Hexene-1 (20 ml) was then added to the pre-mixed catalyst composition. Anhydrous conditions were maintained. The following describes the polymerization process used for Runs 1 to 20 and Runs C1 to C8.

The slurry reactor was a 1 liter, stainless steel autoclave equipped with a mechanical agitator. The reactor was first dried by heating at 95° C. under a stream of dry nitrogen for 40 minutes. After cooling the reactor to 50° C., 500 ml of hexane was added to the reactor, followed by 0.25 ml of tri-isobutylaluminum (TIBA) in hexane (0.86 mole, used as scavenger), and the reactor component was stirred under a gentle flow of nitrogen. The pre-mixed catalyst composition, or in the case of comparative examples of non borate treated systems, was then transferred to the reactor under a stream of nitrogen and the reactor was sealed. The temperature of the reactor was gradually raised to 75° C. and the reactor was pressured to 150 psi (1034 kPa) with ethylene. Heating was continued until a polymerization temperature of 85° C. was attained. Unless otherwise noted, polymerization was continued for 30 minutes, during which time ethylene was continually added to the reactor to maintain a constant pressure. At the end of 30 minutes, the reactor was vented and opened. Tables 2 gives the activity and melt and flow index.

Method 1

In Method 1, the ionizing activator, the bulky ligand metallocene compound, silica supported MAO, and optionally a cycloalkadiene compound such as indene or 1,2-bis(3-indenyl)ethane were all mixed at the same time in Kaydol oil. The resulting mixture was then stirred at room temperature for 16 hours before being the catalyst composition employed for polymerization.

Method 2

In method 2, a solution of the ionizing activator in toluene was mixed with a mineral oil slurry of a supported catalyst prepared according to the above procedure. This ionizing activator/supported catalyst mixture was then stirred at room temperature for about 1 hour before being used for polymerization.

Method 3

In method 3, the ionizing activator was added to a mineral oil slurry of a supported catalyst prepared according to the above procedure. The resulting catalyst composition was then stirred at room temperature for 16 hours before being employed for polymerization.

Method 4

In method 4, a solution of the ionizing activator in toluene was mixed with a toluene slurry of the supported catalyst prepared according to the above procedure. This mixture was then stirred at room temperature for 16 hours and the toluene was removed at the end of stirring under vacuum with mild heating. The resulting free-flowing powder was added to mineral oil and fed as slurry catalyst for polymerization.

TABLE 2

| | | | | Method | | | |
|---|---|---|---|---|---|---|---|
| | | | | of | | | |
| | | | | adding | | | |
| | | Borate/ | Borate | Borate | | | |
| | Cata- | Boron | (Boron)/ | or | | | |
| Run | lyst | Cpd | Zr | Boron | Activity | MI | FI |
| C1 | I | none | 0 | | 5073 | | NF |
| 1 | I | BF-20 | 0.9 | 2 | 44062 | | 0.6 |
| 2 | I | BF-20 | 1.8 | 2 | 57674 | | 1.5 |
| 3 | I | BF-15 | 1.0 | 2 | 6351 | | |
| C2 | II | none | 0 | | 21596 | | 1.3 |
| 4 | II | BF-20 | 0.9 | 2 | 73576 | 0.22 | 5.9 |
| 5 | II | BF-20 | 1.8 | 2 | 78522 | 0.45 | 16.5 |
| C3 | III | none | 0 | | 63230 | | 1.3 |
| 6 | III | BF-20 | 0.9 | 2 | 143238 | 28.7 | |
| 7 | III | BF-20 | 1.8 | 2 | 134758 | 16.7 | |
| 8 | III | BF-15 | 1.0 | 2 | 71774 | | 1 |
| C4 | IV | none | 0 | | 5774 | | NF |
| 9 | IV | BF-20 | 1 | 1 | 54137 | 2 | 47 |
| C5 | V | none | 0 | | 35312 | | 4.1 |
| 10 | V | BF-20 | 1 | 2 | 53605 | 0.4 | 10.5 |
| 11 | V | BF-15 | 1 | 2 | 31844 | | 3.5 |
| C6 | VI | none | 0 | | 44796 | | 1.5 |
| 12 | VI | BF-20 | 0.2 | 2 | 115000 | 6.1 | 124 |
| 13 | VI | BF-20 | 1 | 2 | 128969 | 4.9 | 100 |
| C7 | VII | none | 0 | | 73100 | | 2.5 |
| 14 | VII | BF-20 | 0.1 | 2 | 116024 | 13 | |
| 15 | VII | BF-20 | 0.2 | 2 | 169500 | | 263 |
| 16 | VII | BF-20 | 0.2 | 3 | 192304 | | 106 |
| 17 | VII | BF-20 | 0.2 | 4 | 171128 | | 288 |
| 18 | VII | BF-20 | 1 | 2 | 196090 | | 582 |
| 19 | VII | BF-15 | 1 | 2 | 80566 | | |
| C8 | VIII | none | 0 | | 16571 | 0.1 | 1.8 |
| 20 | VIII | BF-20 | 0.13 | 1 | 91384 | 1.6 | 26.9 |

While the present invention has been described and illustrated by reference to particular embodiments, those of ordinary skill in the art will appreciate that the invention lends itself to variations not necessarily illustrated herein. For example, it is contemplated that two or more supported activators, and two or more bulky ligand metallocene catalyst compounds are used in a mixture with one or more ionizing activators. It is also contemplated that in this embodiment, that the supported activators may be the same or different. For this reason, then, reference should be made solely to the appended claims for purposes of determining the true scope of the present invention.

We claim:

1. A method for preparing a catalyst composition comprising the steps of contacting an activator, a support, a bulky ligand metallocene catalyst compound, and an ionizing activator in a diluent having a flash point of greater than 200° F.

2. The method of claim 1 wherein the activator and support are combined to form a supported activator.

3. The method of claim 1 wherein the diluent is a mineral oil.

4. The method of claim 1 wherein the activator is an alumoxane.

5. The method of claim 1 wherein the ionizing activator is a Group 13 metal containing compound.

6. The method of claim 2 wherein the supported activator is combined with the bulky ligand metallocene catalyst compound in the diluent prior to contacting with the ionizing activator.

7. The method of claim 2 wherein the supported activator is the reaction product of a support material comprising surface hydroxyl groups and an organoaluminum compound.

8. The method of claim 1 wherein the bulky ligand metallocene catalyst compound is a bridged bulky ligand metallocene catalyst compound.

9. The method of claim 1 further comprising contacting a cycloalkadiene compound with the diluent.

10. An activated olefin polymerization catalyst composition comprising an activator, a support, a bulky ligand metallocene catalyst compound, an ionizing activator formed in a diluent having a flash point of greater than 200° F.

11. The catalyst composition of claim 10 wherein the activator and the support are combined to form a supported activator.

12. The catalyst composition of claim 10 wherein the catalyst composition is in a slurry state.

13. The catalyst composition of claim 12 wherein the catalyst composition is slurried in mineral oil.

14. The catalyst composition of claim 11 wherein the supported activator is supported alumoxane.

15. The catalyst composition of claim 10, wherein the ionizing activator is.

16. The catalyst composition of claim 10 wherein the mole ratio of the metal of the ionizing activator to the transition metal of the bulky ligand metallocene catalyst compound is from 0.05 to 5.0.

17. The catalyst composition of claim 10 further comprising a cycloalkadiene.
